(19) United States
(12) Patent Application Publication
(10) Pub. No.: US 2015/0076297 A1
(43) Pub. Date: Mar. 19, 2015

(54) MODULAR HANDLE AND STAND FOR ELECTRONIC DEVICES

(71) Applicant: Matthew Brian Parrill, Winchester, VA (US)

(72) Inventor: Matthew Brian Parrill, Winchester, VA (US)

(21) Appl. No.: 14/466,451

(22) Filed: Aug. 22, 2014

Related U.S. Application Data
(60) Provisional application No. 61/869,743, filed on Aug. 25, 2013.

(51) Int. Cl. F16M 11/12

(52) U.S. Cl. CPC F16M 11/12
USPC 248/176.3

(57) ABSTRACT

A Modular Handle And Stand For Electronic Devices is disclosed that aids the use of cameras, smartphones, portable music players, tablet computers, or multiple such devices used in tandem. The modular system is comprised of a handle, various accessory heads, a means of attachment, and an optional charging battery enclosed in the handle for charging the attached device(s). The modularity of the design allows the device to be easily adapted to multiple device types, as well as a plurality of devices. It allows a device to be attached to the handle with or without that device being placed within a case or enclosure, and creates the option of using the internal cavity of the handle to be used for hosting a removable battery or for storage. The invention may be used as a handle for capturing video or still images, as a multi-position stand that replaces the need to carry a standard tripod, and may be expanded with additional modules to support current and future devices and accessories.

### CROSS-REFERENCE TO RELATED APPLICATION

The present application claims the benefit under 35 U.S.C. §119(e) of U.S. Provisional Patent Application No. 61/869,743 filed Aug. 25, 2013 and entitled “Detachable Handle for Camera or Smartphone,” the entire contents of which is hereby incorporated by reference herein.

### BACKGROUND

1. Field

The present invention relates to devices that are used to capture still images, or motion video. These devices, most notably cameras, smartphones, portable music players, and tablet computers are commonly equipped with image sensors and internal media storage for capturing and storing image data. Over time, these modern devices have been reduced in size. As a result they have become more difficult to hold comfortably over periods of time. With the growing obsolescence of traditional devices like camcorders and cameras that often included integrated gripping areas, the users of modern devices have collectively lost the much-needed handle feature that had once been used to firmly hold and point traditional image-capturing devices.

As not only image-capturing devices, but lightweight and pocket-sized accessories that also provide a growing percentage of our communication, the variety of these modern devices presents other unique needs such as the modularity to universally support multiple device types, a need for a small, portable, tripod-type solution that can fit in a pocket, and an integrated ability to recharge the internal batteries of such devices.

As can be seen, there is a need for a modular handle that may be removably attached to these various modern devices, creating the control of traditional devices, the modularity to universally support multiple device types, the ability to act as a tripod-type device while maintaining the portability and lightweight aspects of modern devices, and the option of housing a battery for device charging.

2. Related Art

Integrated and auxiliary handles have been employed for traditional video cameras for many years. These devices have been standardized around the ¼-20 threaded attachment screw and threaded insert that are commonly found on camera tripod-type devices. Some examples of these auxiliary devices can be seen in U.S. Pat. Nos. 5,585,849, and 5,121,147. Other thread-att45ached devices have included additional functionality such as the internal bipod disclosed in U.S. Pat. No. 4,545,660. In theory, these devices may still be used as accessories for modern devices, but their proportion and weight make them undesirable for smaller, modern devices that do not include a camera tripod-type mounting interface.

Handle-like inventions that are intended for modern devices have been disclosed that feature device-specific connectivity, power port connections that are specifically for the purpose of remote control, include internal electronics and controls that integrate with smartphone applications via a wired or wireless connection, and require a case or enclosure for a given device to which a handle connection is then made. Some examples of these disclosures can be seen in U.S. Patent applications US20130005401 and US20140179372. Although these devices offer specialized electronics and control surfaces, they do not resolve the need for a modular, universal, and multi-position device that acts as a handle and a stand without the need for a standard tripod-threaded attachment, nor do they offer the inclusion of an optional charging battery.

### SUMMARY

Broadly, an embodiment of the present invention provides a modular handle and stand that may be removably attached to an image-capturing device such as a camera, smartphone, portable music player, or tablet computer. The present invention is comprised of a handle, interchangeable accessory heads that provide an adaptable means of functionality and support for multiple device types, a means of attaching the interchangeable accessory heads to the handle, and an attachment mechanism that allows the modular handle to be removably attached to a hosted device.

In another embodiment, the interchangeable accessory heads may removably attach directly to the handle component by friction, snap fit, tabs and slots, bolt(s), screw(s), other means suitable for removably attaching two components, or some combination of these.

In another embodiment, the interchangeable accessory heads may be removably attached to the handle component by an intermediary device such as a retaining cap. The retaining cap may be sized to removably connect within or around the handle with friction, snap fit, tabs and slots, bolt(s), screw(s), other means suitable for removably attaching two components, or some combination of these. A given interchangeable accessory head may then be inserted into or on to the retaining cap thereby removably joining the accessory head and the handle.

In another embodiment, the attachment mechanism may be comprised of a male mounting tab, or tabs, at either end or both ends of a handle, and a female receiver component, or components. A band, or bands, of an elastomeric, polymeric, or woven material may be used to removably attach some or all of the attachment mechanism to the hosted device. Some or all of the attachment mechanism could then remain attached to the hosted device after the handle itself is detached.

In another embodiment, the attachment mechanism may be comprised of a male mounting tab, or tabs, at either end or both ends of a handle, and a female receiver component, or components, removably attached to a device by a suction cup, or suction cups.

In another embodiment, the attachment mechanism may be comprised of a male mounting tab, or tabs, at either end or both ends of a handle, and a female receiver component, or components, removably attached to a device by a substrate suitable for sufficient adhesion.

In another embodiment, the attachment mechanism may be a male mounting tab, or tabs, at either end or both ends of a handle, removably attached directly to a device by a band, or bands.

In another embodiment, the attachment mechanism may be a male mounting tab, or tabs, at either end or both ends of a handle, removably attached directly to a device by a suction cup, or suction cups.

In another embodiment, the attachment mechanism may be a male mounting tab, or tabs, at either end or both ends of a handle, removably attached directly to a device by a substrate suitable for sufficient adhesion.

In another embodiment, the attachment mechanism may be a female receiver component that is integrated into a case or enclosure that is designed to removably enclose at least a portion of the electronic device.

In another embodiment, the modular handle interfaces with a linear accessory head that acts as a monopod or includes a fixed point of attachment.

In another embodiment, the modular handle interfaces with an accessory head that conforms to multiple positions. These positions allow the handle to fold into a configuration that allows the handle to be held in the hand or support an electronic device on a surface.

In another embodiment, the modular handle interfaces with a multiple accessory head that supports a plurality of devices such as smartphones, portable music players, tablets, cameras, or some combination of these. This accessory head may host the devices in tandem, one in front of the other, or in a stacked configuration to accommodate various device designs.

In another embodiment, the modular handle may include a removable battery.

In another embodiment, the modular handle interfaces with an accessory head that may include nested components, which slide one within another in a telescopic manner to allow the accessory head to be extended.

In another embodiment, the disclosed modular handle may include nested handle components, which slide one within another in a telescopic manner to allow the handle to be extended.

### BRIEF DESCRIPTION OF THE DRAWINGS

FIG. 1 displays a perspective view of an exemplary modular handle and stand with an attachment mechanism.

FIG. 2 displays a perspective view of an exemplary modular handle and stand with a detached attachment mechanism that is removably attached to a smartphone as a sample device.

FIG. 3 displays a perspective view of an exemplary modular handle and stand removably connected to an attachment mechanism, which is removably attached to a smartphone as a sample device.

FIG. 4 displays a perspective view of an exemplary attachment mechanism removably attached to a smartphone as a sample device.

FIG. 5 displays a perspective view of an exemplary modular handle and stand removably attached directly to a smartphone as a sample device.

FIG. 6 is a back view that illustrates the stand feature of an exemplary modular handle and stand in a 90-degree orientation with a removably joined attachment mechanism and handle removably attached to a smartphone as a sample device.

FIG. 7 is a back view that illustrates the stand feature of an exemplary modular handle and stand in a 90-degree orientation with a removably joined attachment mechanism attached to a smartphone as a sample device.

FIGS. 8-A, and 8-B are back and side views respectively that illustrate the stand feature of an exemplary modular handle and stand in an upright, linear orientation with a removably joined attachment mechanism removably attached to a smartphone as a sample device.

FIGS. 9 and 9A display exploded perspective views of an exemplary modular handle and stand with a removable battery.

FIG. 10 displays an exploded perspective view of an exemplary modular handle and stand with interchangeable mounting heads.

FIG. 11 displays a perspective view of an exemplary modular handle and stand with a multiple device mounting head, an encased smartphone, and an encased camera mounted in tandem.

### DETAILED DESCRIPTION OF THE DRAWINGS

The following description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Example embodiments will become more fully understood from the detailed description given herein below and the accompanying drawings, wherein like elements are represented by like reference numerals, which are given by way of illustration only and thus are not limitative of the example embodiments herein.

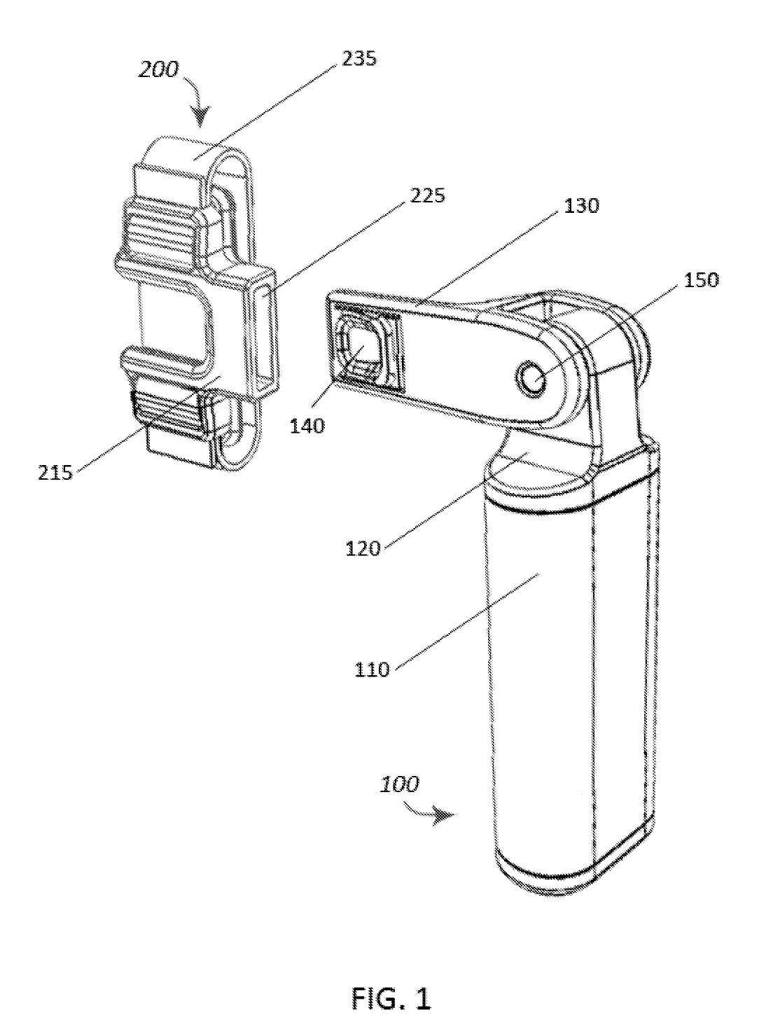

FIG. 1 displays a perspective view of an exemplary modular handle and stand 100 and a detached attachment mechanism 200. A handle 110 is shown connected to a multi-position accessory head 120. A male mounting tab 130, shown in a 90-degree orientation, with a release tab 140 is connected to multi-position accessory head 120 with pin 150. Pin 150 allows the male mounting tab 130 to rotate to desired positions. Indexed protrusions on the outer surface of accessory head 120 may engage corresponding detents on the inner surface of male mounting tab 130, or vice versa. The attachment mechanism 200 is shown with a female receiver component 215 and a female mounting slot 225. As mounting tab 130 engages female mounting slot 225 of attachment mechanism 200, release tab 140 compresses. When mounting tab 130 is fully engaged, release tab 140 decompresses, capturing male mounting tab 130 in female receiver component 215, thereby removably attaching modular handle 100 to attachment mechanism 200. An exemplary band 235 removably attaches the attachment mechanism 200 to an electronic device.

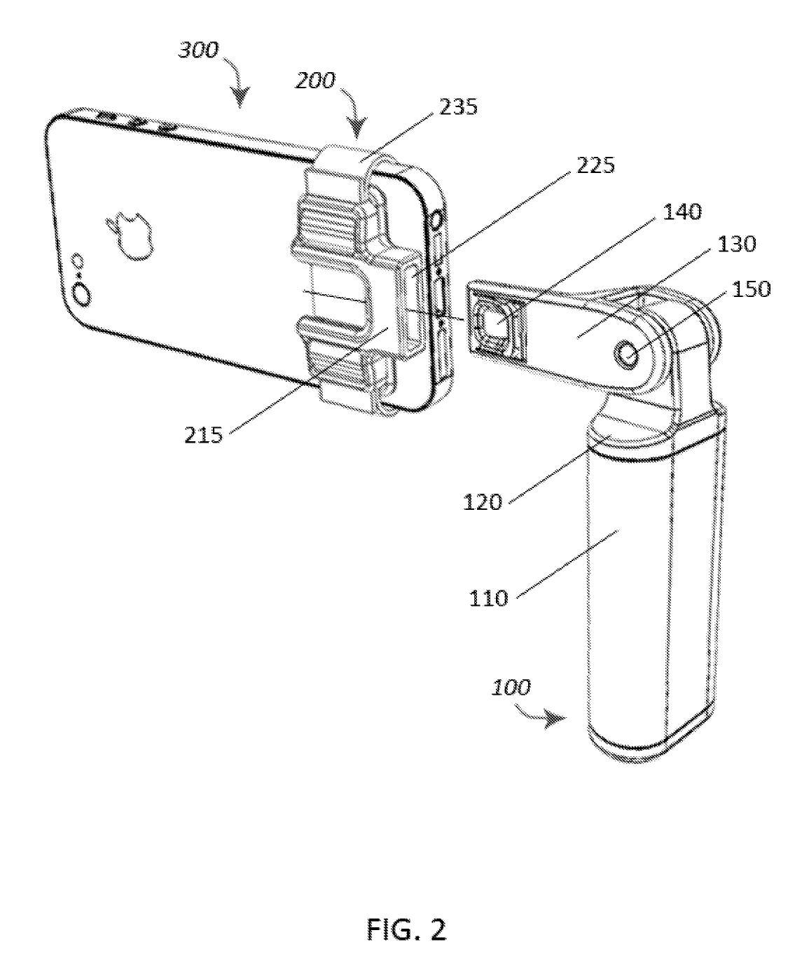

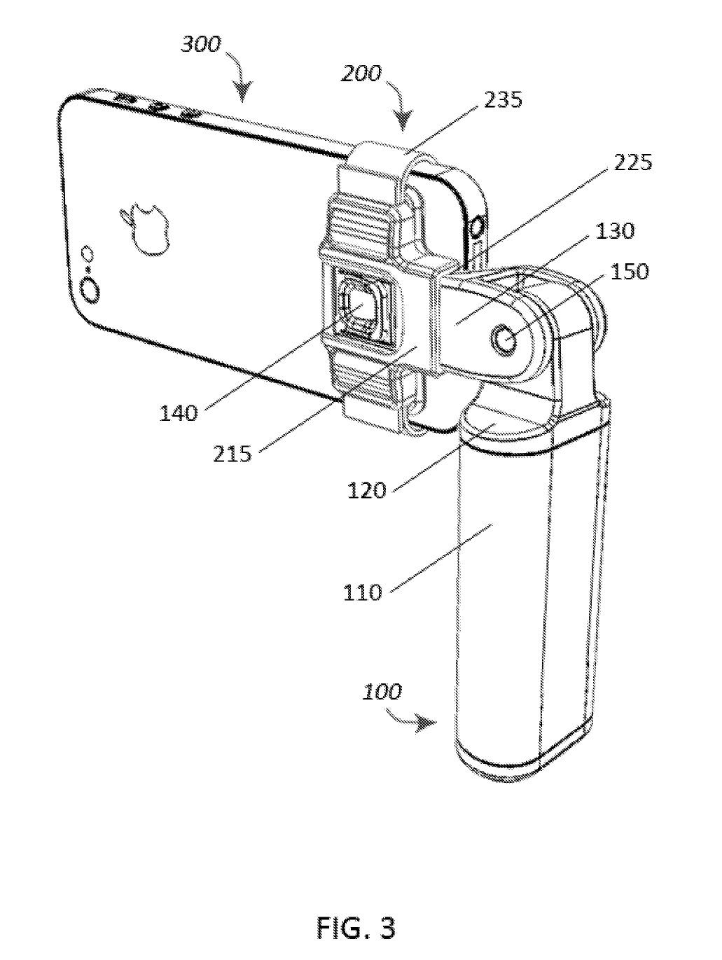

FIGS. 2 and 3 display perspective views of an exemplary modular handle and stand 100, attachment mechanism 200, and smartphone 300. A handle 110 is shown connected to a multi-position accessory head 120 of modular handle and stand 100. A male mounting tab 130, shown in a 90-degree orientation, with a release tab 140 is connected to multi-position accessory head 120 with pin 150. The attachment mechanism 200 is shown with a female receiver component 215 and a female mounting slot 225. Here, attachment mechanism 200 is connected to a smartphone 300 by exemplary band 235. FIG. 2 shows the modular handle and stand 100 detached from attachment mechanism 200 and smartphone 300. FIG. 3 shows the modular handle and stand 100 removably attached to attachment mechanism 200, which is removably attached to smartphone 300.

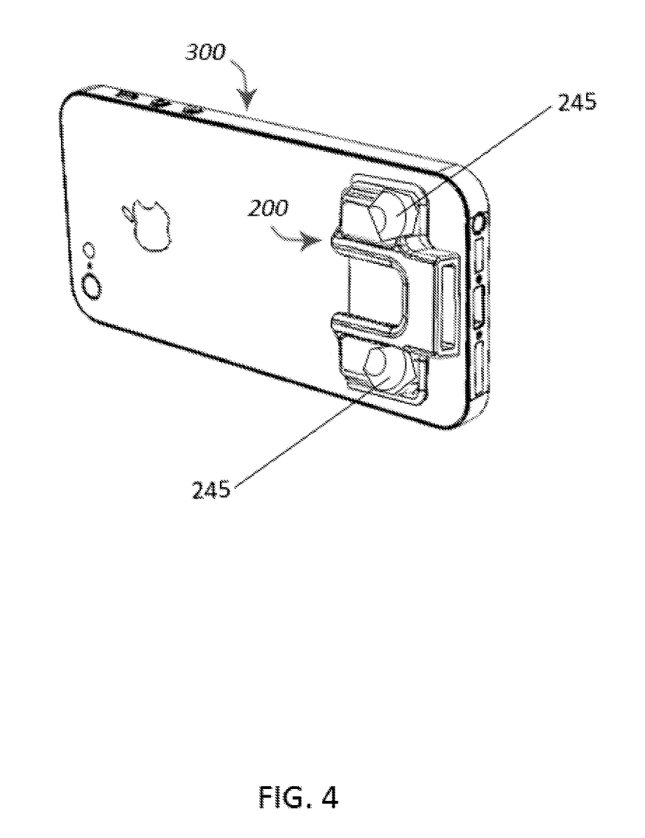

FIG. 4 displays a perspective view of an exemplary embodiment of attachment mechanism 200 with smartphone 300. Cutaways in attachment mechanism 200 reveal suction cup(s) or adhesive substrate(s) 245 that removably attach attachment mechanism 200 to smartphone 300.

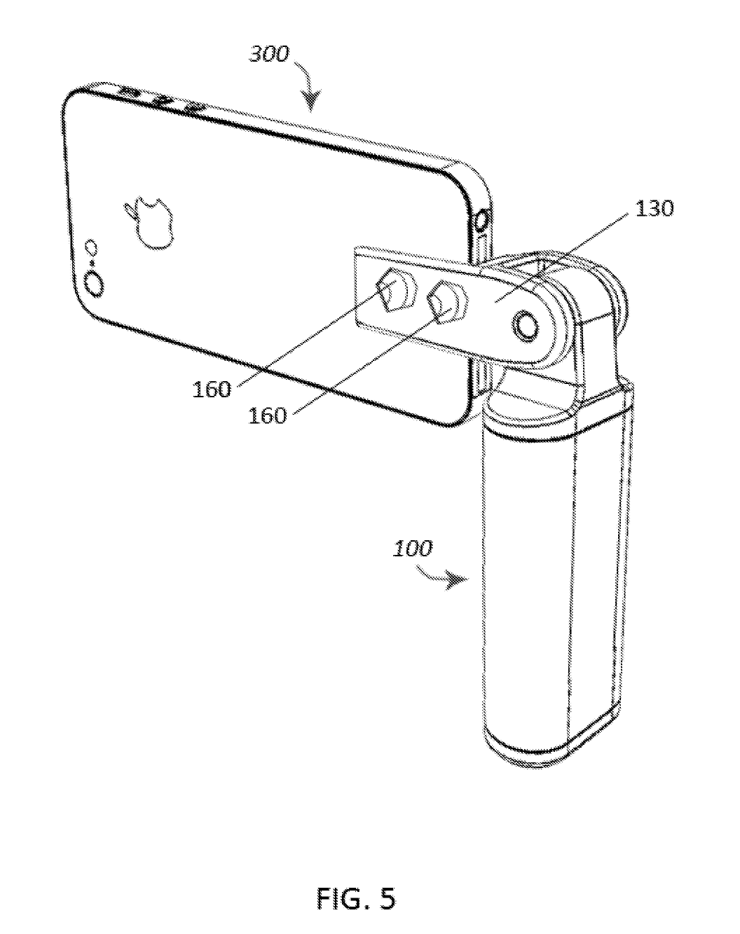

FIG. 5 displays a perspective view of an exemplary embodiment of modular handle and stand 100 with smartphone 300. Cutaways in mounting tab 130 of modular handle and stand 100 reveal suction cup(s) or adhesive substrate(s) 160 that removably attach mounting tab 130 directly to smartphone 300 without the need for an additional attachment mechanism.

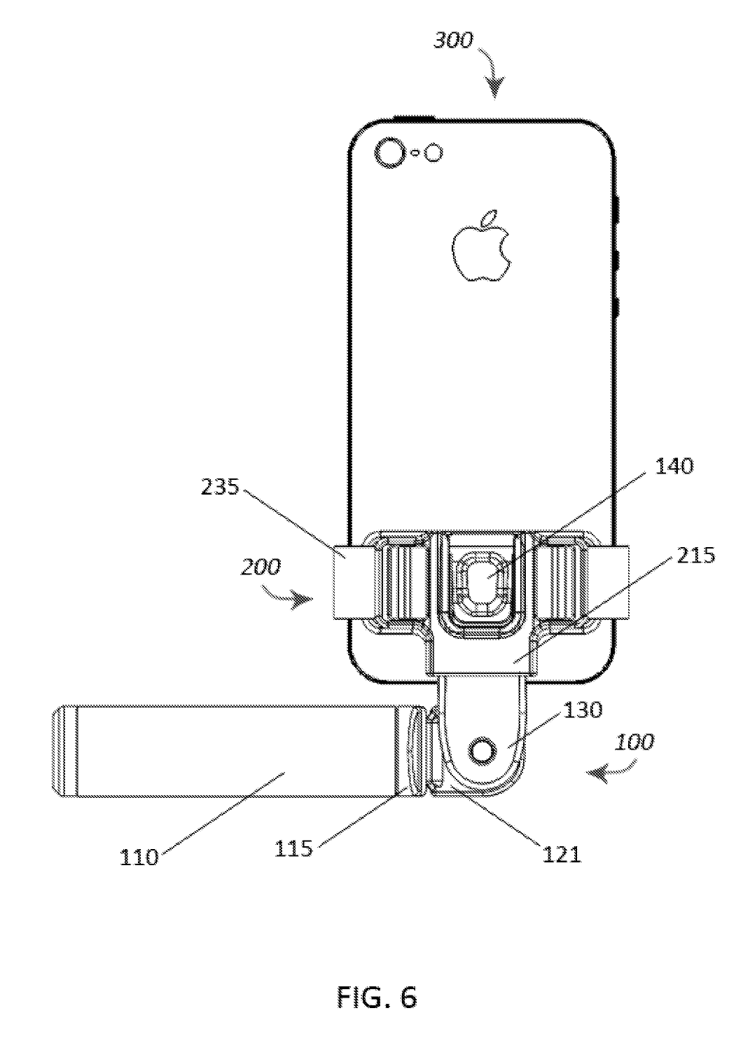

FIG. 6 displays a back view of an exemplary modular handle and stand 100 and attachment mechanism 200, with smartphone 300. The drawing illustrates a single stand position of modular handle and stand 100, allowing smartphone 300 to be placed in a vertical orientation on a surface. Handle 110 is shown with an attached multi-position accessory head 121 and retaining cap 115. To achieve this position, indexed protrusions on the outer surface of accessory head 121 may engage corresponding detents on the inner surface of male mounting tab 130, or vice versa. Male mounting tab 130, in a 90-degree orientation, is fully inserted into female receiver component 215, thereby engaging release tab 140. Handle 110 is thereby removably attached to the female receiver component 215 of attachment mechanism 200. Attachment mechanism 200 is removably attached to smartphone 300 by exemplary band 235.

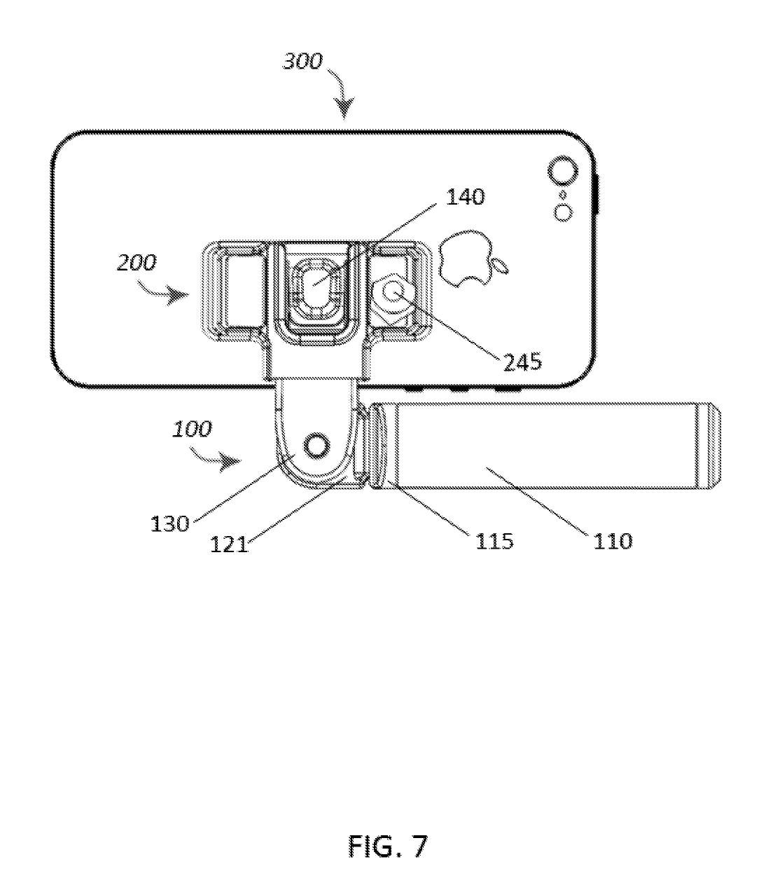

FIG. 7 displays a back view of an exemplary embodiment of modular handle and stand 100 and attachment mechanism 200, with smartphone 300. The drawing illustrates a single stand position of modular handle and stand 100, allowing smartphone 300 to be placed in a horizontal orientation on a surface. Handle 110 is shown with an attached multi-position accessory head 121 and retaining cap 115. To achieve this position, indexed protrusions on the outer surface of accessory head 121 may engage corresponding detents on the inner surface of male mounting tab 130, or vice versa. Male mounting tab 130, in a 90-degree orientation, is fully inserted into female receiver component 215, thereby engaging release tab 140. Handle 110 is thereby removably attached to the female receiver component 215 of attachment mechanism 200. A cutaway in attachment mechanism 200 reveals that is removably attached to smartphone 300 by suction cup(s) or adhesive substrate(s) 245.

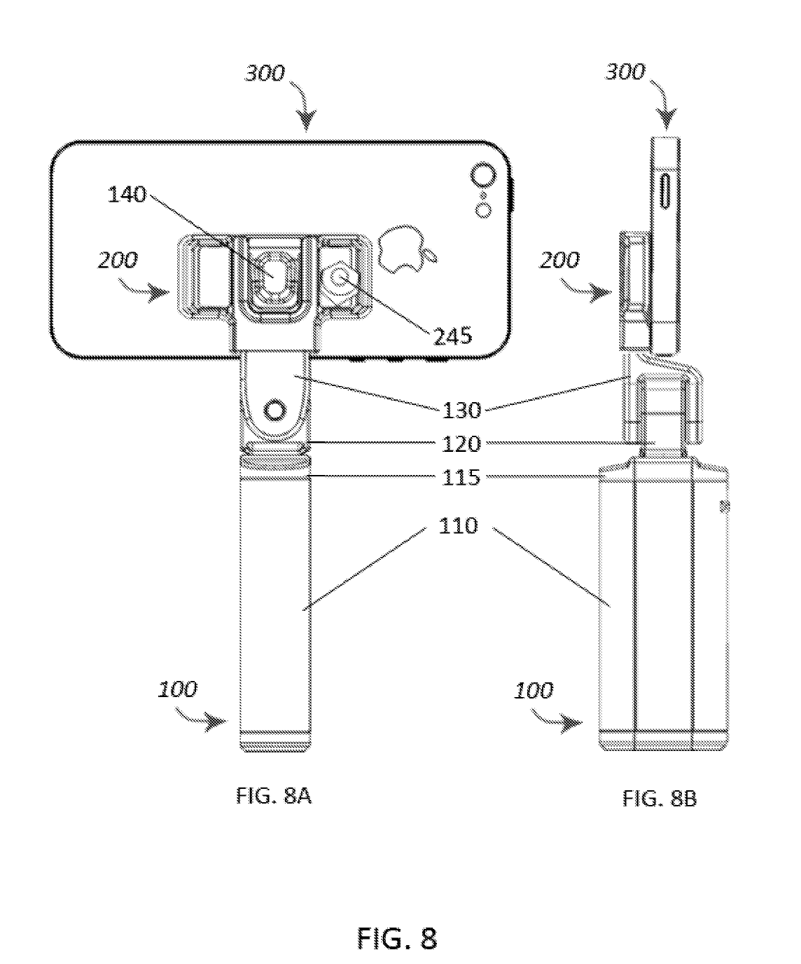

FIGS. 8A and 8B are respectively back and side views of exemplary embodiments of modular handle and stand 100 and attachment mechanism 200, shown with smartphone 300. The drawings illustrate a single stand position of modular handle and stand 100, allowing smartphone 300 to be raised vertically above a surface in a horizontal orientation. Handle 110 is shown with an attached multi-position accessory head 121 and retaining cap 115. To achieve this position, indexed protrusions on the outer surface of accessory head 121 may engage corresponding detents on the inner surface of male mounting tab 130, or vice versa. Male mounting tab 130, in a vertical, linear orientation, is mated to attachment mechanism 200. Handle 110 is thereby removably attached to attachment mechanism 200. A cutaway in attachment mechanism 200 reveals that is removably attached to smartphone 300 by suction cup(s) or adhesive substrate(s) 245.

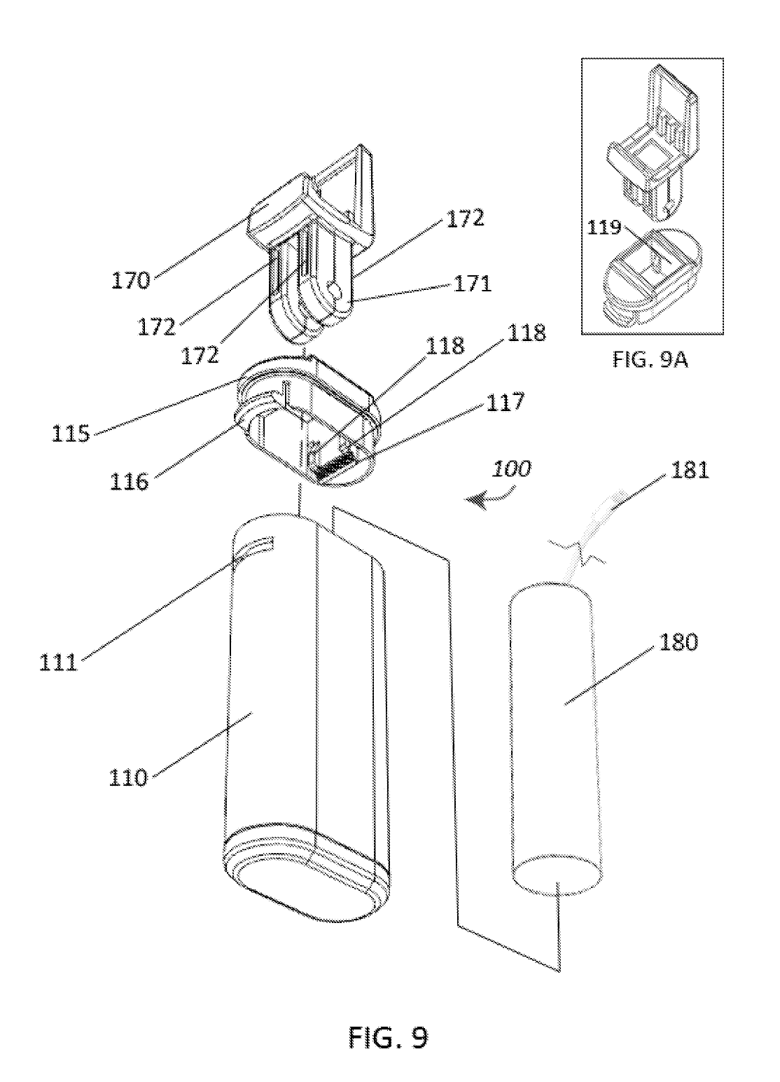

FIG. 9 and inset FIG. 9A display exploded perspective views of an exemplary embodiment of modular handle and stand 100. Handle 100 is shown with slot 111. Retaining tab 116 of retaining cap 115 engages slot 111 of handle 110 to removably attach retaining cap 115 to handle 110. As shown in inset FIG. 9A, accessory head 170 engages aperture 119 in the top of retaining cap 115. When the reversible mounting tabs 171 of accessory head 170 fully engage retaining cap 115, female slots 172 engage male protrusion(s) 118 of accessory head retaining tab 117. In this exemplary embodiment, individual accessory heads would share the common base structure that makes up the reversible mounting tabs 171. Additionally, optional battery 180 and optional battery cable 181 are shown removed from the inner cavity of handle 110.

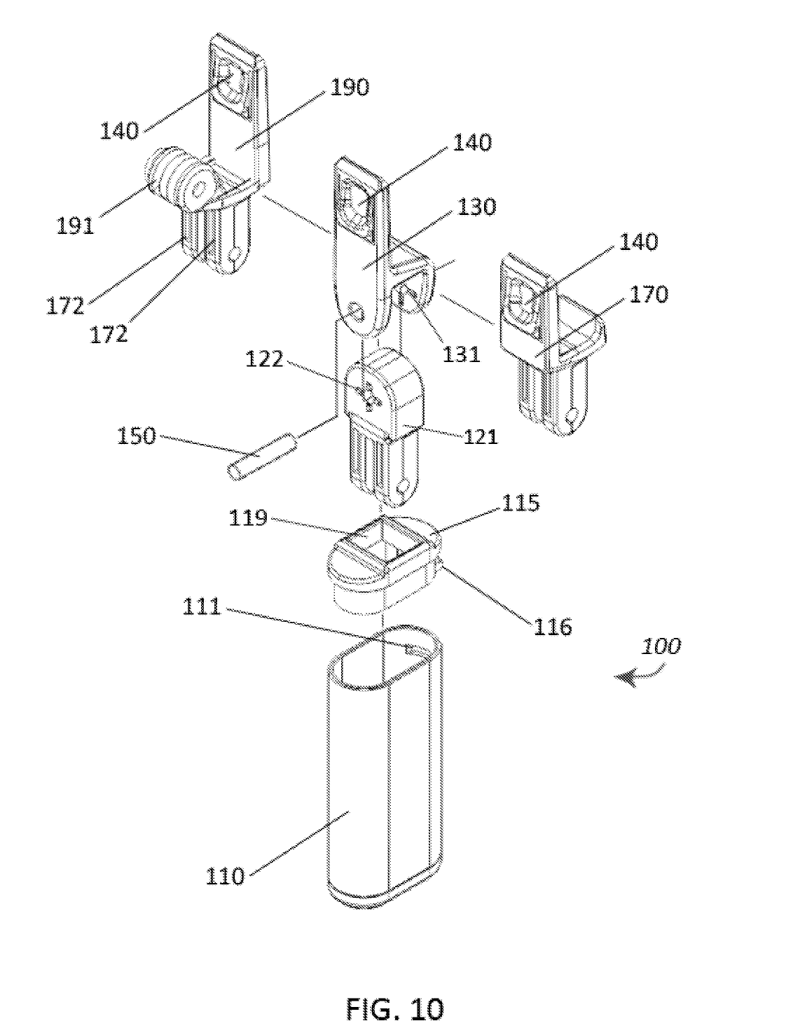

FIG. 10 displays an exploded perspective view of an exemplary modular handle and stand 100 with a static interchangeable mounting head 170, a multi-position interchangeable mounting head that is comprised of a multi-position accessory head 121, male mounting tab 130 and pin 150, and multiple device mount 190. Each is shown with a release tab 140. The disclosed modular system allows each of these modular accessories to be used interchangeably, each being inclusive of reversible female slots 172, and each being removably captured as they are inserted into aperture 119 of retaining cap 115. Retaining cap 115 is removably captured by handle 110 as retaining tab 116 engages slot 111. Multi-position accessory head 121 and a male mounting tab 130 are joined by pin 150. In this exemplary embodiment, indexed protrusions 122 on the outer surface of multi-position accessory head 121 may engage corresponding detents 131 on the inner surface of male mounting tab 130 thereby allowing male mounting tab 130 to rotate around pin 150 while indexing at predetermined angles. Referring now to multiple device mount 190, the modular component is shown with an exemplary secondary mount 191 that used to attach a secondary device. The purpose of the dual mount is two-fold; a user may choose to use his or her primary device as an ancillary display for the secondary device, or simply use secondary mount 191 to hold the secondary device while using the primary and secondary devices independently. The disclosed accessory heads are not to be taken in a limiting sense as numerous adaptations can be made to accept any single device, or any combination of a plurality of devices.

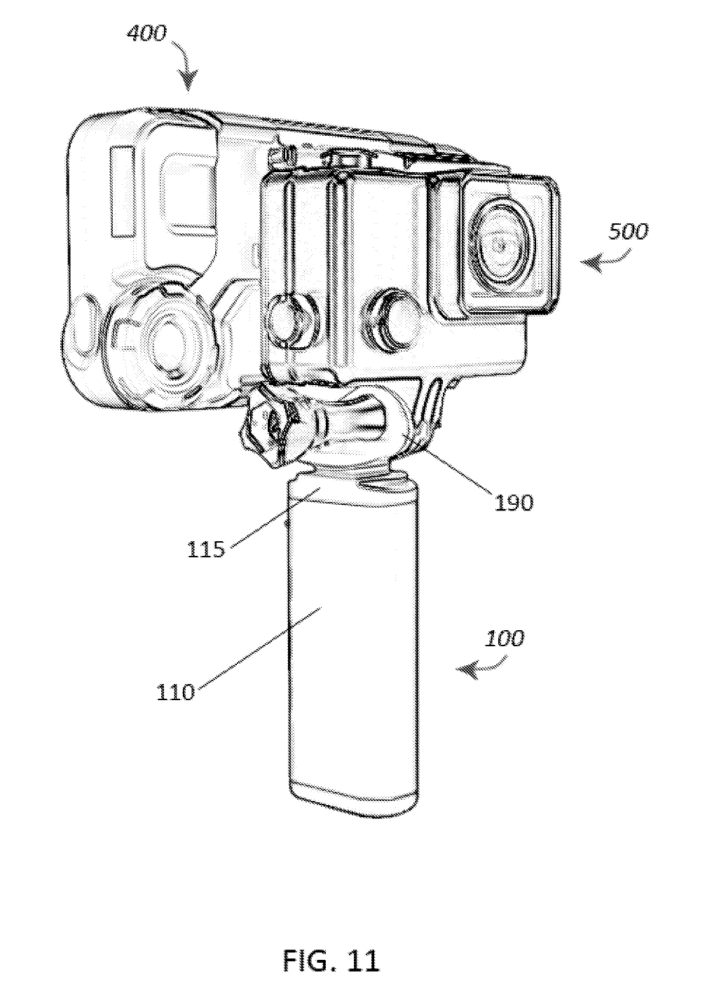

FIG. 11 displays a perspective view of an exemplary modular handle and stand 100 attached to multiple device mount 190 by retaining cap 115, a sample encased smartphone 400, and a sample encased camera 500. Such a configuration of an encased smartphone 400 as a primary device and an encased camera 500 as a secondary device allows the user of modular handle and stand 100 to use the invention is situations that may not be safe for the surfaces and electronics of unprotected devices.

Referring generally to FIGS. 1-11 there are many suitable materials, methods of manufacturing, and combinations of materials and methods of manufacturing that may be used in the construction of such a device. Although injection molded thermoplastics may be preferred for the primary components, the components may also be manufactured from machined plastics, other polymeric or elastomeric compounds, cast metals, machined metals, wood, or other suitable materials. Specific materials, or a combination of materials, may be selected for specific requirements such as form, weight, operational performance, longevity, texture, or any other purpose.

While the invention has been described with particular reference to the preferred embodiments, it is apparent that variations and modifications are possible within the purview of the inventive concepts. No limitation with respect to such variations and modifications is intended.

What is claimed:

1. A modular handle and stand for electronic devices, the device comprising:
a handle;
interchangeable accessory heads removably attachable to said handle; and
an attachment mechanism that may be removably attached to one or more electronic devices;

2. The modular handle and stand for electronic devices of claim 1, wherein the attachment mechanism is comprised of a female receiving component and a male mounting component

3. The modular handle and stand for electronic devices of claim 1, wherein the attachment mechanism is removably attached to an electronic device with a band

4. The modular handle and stand for electronic devices of claim 1, wherein the attachment mechanism is removably attached to an electronic device with a suction cup or suction cups

5. The modular handle and stand for electronic devices of claim 1, wherein the attachment mechanism is removably attached to an electronic device with an adhesive substrate

6. The modular handle and stand for electronic devices of claim 1, wherein one said accessory head is configurable to multiple positions as a stand

7. The modular handle and stand for electronic devices of claim 1, wherein one or more components are comprised of nested features that extend telescopically

8. The modular handle and stand for electronic devices of claim 1, wherein is included a removable battery

9. A modular handle and stand for electronic devices, the device comprising:
a handle;
interchangeable accessory heads removably attachable to said handle; and
an attachment mechanism that may be removably attached to one or more electronic devices;

10. The modular handle and stand for electronic devices of claim 9, wherein the attachment mechanism is comprised of a male mounting component that connects directly to an electronic device

11. The modular handle and stand for electronic devices of claim 9, wherein the attachment mechanism is removably attached to an electronic device with a band

12. The modular handle and stand for electronic devices of claim 9, wherein the attachment mechanism is removably attached to an electronic device with a suction cup or suction cups

13. The modular handle and stand for electronic devices of claim 9, wherein the attachment mechanism is removably attached to an electronic device with an adhesive substrate

14. The modular handle and stand for electronic devices of claim 9, wherein one said accessory head is configurable to multiple positions as a stand

15. The modular handle and stand for electronic devices of claim 9, wherein one or more components are comprised of nested features that extend telescopically

16. The modular handle and stand for electronic devices of claim 9, wherein is included a removable battery
